(19) United States
(12) Patent Application Publication
(10) Pub. No.: US 2008/0261589 A1
(43) Pub. Date: Oct. 23, 2008

(54) Mobile radio terminal

(75) Inventors: Michiaki Okano, Yokohama-shi (JP); Yukio Kagami, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/006,003

(22) Filed: Dec. 28, 2007

(30) Foreign Application Priority Data
Apr. 20, 2007 (JP) 2007-112253

(51) Int. Cl. H04Q 7/20

(52) U.S. Cl. 455/432.1

(57) ABSTRACT

Even if domestic roaming setting is ON (domestic roaming setting flag is ON) (YES in step 2h), it is discriminated on the basis of information transmitted from the other carrier network whether the mobile radio terminal is permitted to execute roaming and whether the other carrier network permits the own carrier network to execute the roaming (step 2m). If the roaming is not permitted, the roaming setting is turned OFF (step 2n) and, after that, the other carrier network is not searched (NO in step 2h).

### CROSS-REFERENCE TO RELATED APPLICATIONS

This application is based upon and claims the benefit of priority from prior Japanese Patent Application No. 2007-112253, filed Apr. 20, 2007, the entire contents of which are incorporated herein by reference.

### BACKGROUND OF THE INVENTION

1. Field of the Invention

The present invention relates to a mobile radio terminal having a roaming function such as a cellular telephone.

2. Description of the Related Art

A cellular telephone has a roaming function. When a cellular telephone is located outside a service network of a carrier under contract, the cellular telephone can obtain the communication service by taking advantage of a service network of the other carrier under contract on roaming by the roaming function.

Conventionally, power consumption has been reduced by varying the frequency of intermittently capturing control channels in a home carrier mobile communication network and a roaming carrier mobile communication network (cf., for example, Jpn. Pat. Appln. KOKAI Publication No. 9-215039).

However, if the cellular telephone is located outside the service network of the carrier under contract, in a system environment where the user is not a subscriber to the roaming service, the roaming contract between the carriers is canceled, or roaming cannot be executed in a state in which the roaming function of the cellular telephone works, the cellular telephone searches for a network for roaming though the roaming cannot be executed. For this reason, the electric power is unnecessarily consumed.

A conventional mobile radio terminal has a problem that if the mobile radio terminal is located outside the service network of the carrier under contract, in a system environment where roaming cannot be executed in a state in which the roaming function works, the mobile radio terminal searches for a network for roaming and the electric power is unnecessarily consumed though the roaming cannot be executed.

### BRIEF SUMMARY OF THE INVENTION

The present invention has been accomplished to solve the above-described problems. The object of the present invention is to provide a mobile radio terminal capable of reducing unnecessary power consumption in an environment that the roaming cannot be executed.

To achieve this object, an aspect of the present invention is a mobile radio terminal, comprising: a memory unit which stores roaming setting; a detector which, if the roaming setting stored in the memory unit is turned ON in a case where the mobile radio terminal is located outside a service zone of a mobile communications network of a carrier in contact, detects a radio signal transmitted from a mobile communications network of the other carrier; and a setting control unit which sets the roaming setting stored in the memory unit to be turned OFF, if the roaming to the mobile communications network of the other carrier detected by the detector is not permitted to the mobile radio terminal.

The present invention comprises a memory unit which stores the roaming setting. In a case where the mobile radio terminal is located outside the service area of the mobile communications network of the carrier under contract, if the roaming setting stored in the memory unit is ON, the radio signal transmitted from the mobile communications network of the other carrier is detected. If the roaming to the mobile communications network of the other carrier detected by the detector is not permitted to the mobile radio terminal, the roaming setting stored in the memory unit is set to be turned OFF.

Thus, even if the setting for executing the roaming is ON, when the roaming is not permitted by the mobile communications network, the roaming is set to be OFF to prohibit the roaming. Therefore, unnecessary power consumption in the environment in which the roaming cannot be carried out can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a mobile radio terminal according to an embodiment of the present invention;

FIG. 2 is a flowchart showing operations concerning roaming in the mobile radio terminal shown in FIG. 1;

FIG. 3 is a flowchart showing a search setting process in the flowchart shown in FIG. 2; and

FIG. 4 is a flowchart showing a search setting process in the flowchart shown in FIG. 2.

### DETAILED DESCRIPTION OF THE INVENTION

An embodiment of the present invention will be described below with reference to the accompanying drawings.

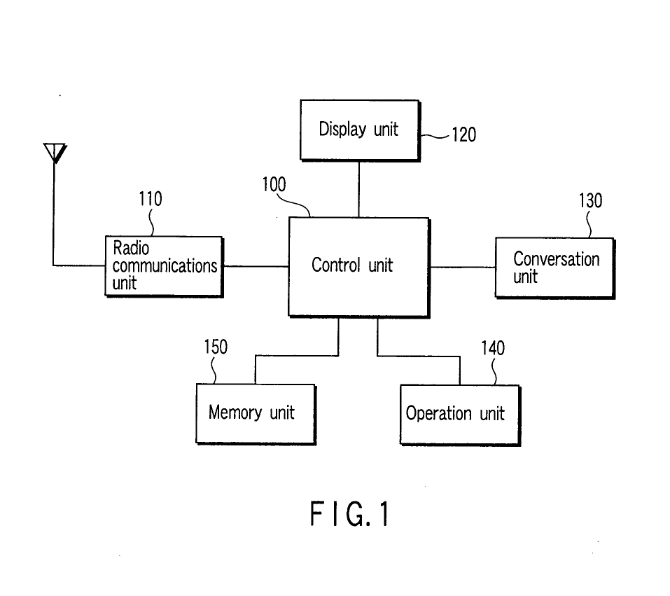

A mobile radio terminal according to the present invention comprises, as its main constituent elements, a control unit 100, a radio communications unit 110, a display unit 120, a conversation unit 130, an operation unit 140 and a memory unit 150 as shown in FIG. 1.

The radio communications unit 110 establishes radio communications with a base station apparatus (not shown), under an instruction of the control unit 100.

The display unit 120 displays images (still images and moving images), character information and the like to visually transmit the information to the user, under an instruction of the control unit 100.

The conversation unit 130 comprises a microphone configured to convert user's transmission speech into an electric signal, an encoding unit configured to encode and convert the electric signal into speech data, a decoding unit configured to decode and convert the speech data received from a conversation partner into an electric signal, a speaker configured to output the electric signal, and the like.

The operation unit 140 comprises a plurality of key switches and the like to receive instructions from the user via the key switches and the like.

The memory unit 150 stores control programs and control data (for example, domestic and foreign roaming setting flags, search setting data, updating date and time data) of the control unit 100, application software, address data associated with names, telephone numbers and the like of the communications partners, transmitted and received e-mail data, Web data downloaded by web browsing, downloaded streaming data, and the like.

The control unit 100 comprises a microprocessor, which operates under the control programs and control data stored in the memory unit 150 to control all the units of the mobile radio terminal and implement speech communications and data communications. The control unit 100 also operates under the application software stored in the memory unit 150, and has a communications controlling function of transmitting and receiving e-mail letters, executing Web browsing, displaying the moving images on the display unit 120 on the basis of the downloaded streaming data, and executing speech communications. In addition, the control unit 100 has a timer function of measuring the date and time, and discriminates the necessity of roaming and executes the control for roaming on the basis of the roaming setting flags and the search setting data.

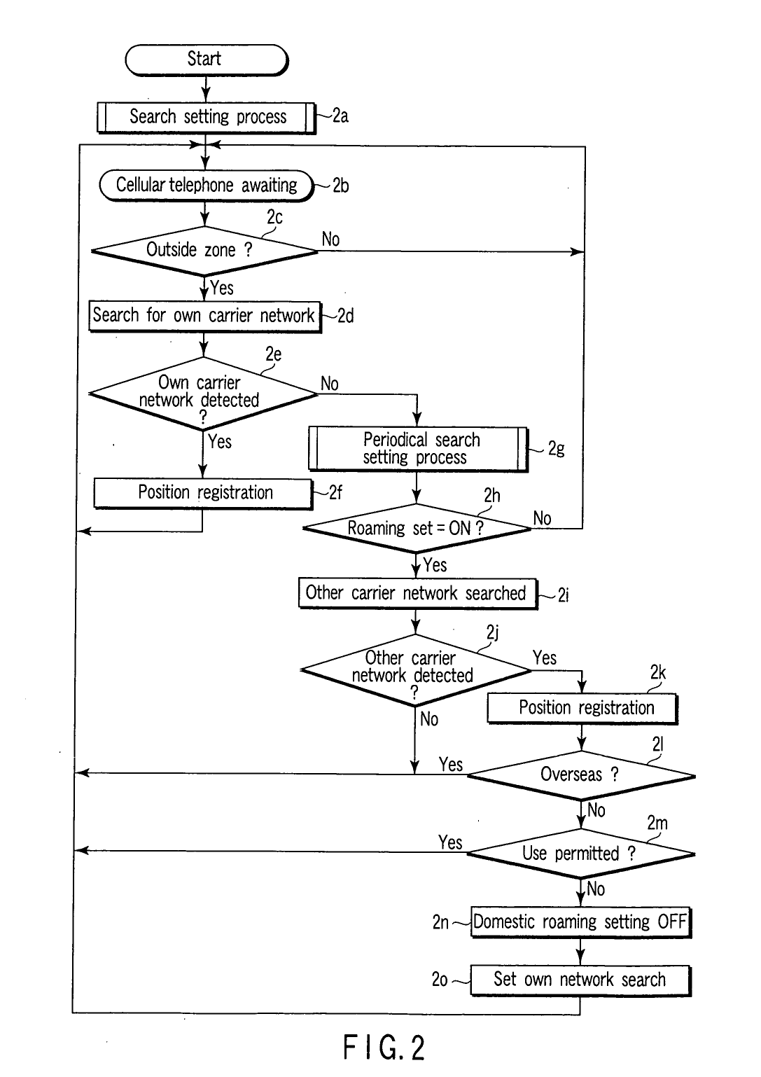

Next, operations of the mobile radio terminal having the above-described configuration are explained. The following explanation is particularly focused on the control function on roaming according to the present invention. FIG. 2 is a flowchart explaining the control on roaming executed by the control unit 100. The process shown in FIG. 2 is repeated until the power of the mobile radio terminal is turned off.

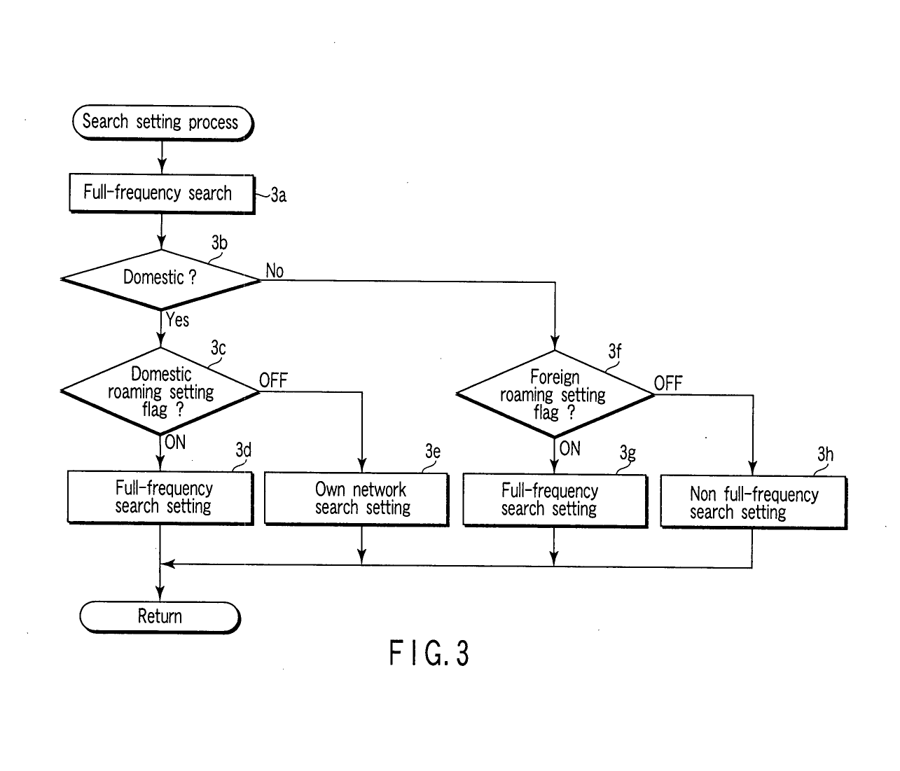

First, in step 2a, the control unit 100 searches for all the frequencies that can be used for communications between a base station of a carrier under contract (hereinafter called “own carrier”) and a base station of the other carrier (hereinafter called “other carrier”), discriminates whether the mobile radio terminal is located in a domestic area or overseas, and executes a search setting process for setting search setting data in accordance with a roaming setting flag stored in the memory unit 150. The search setting process will be described with reference to FIG. 3.

In step 3a, the control unit 100 searches for all the frequency bands that can be used for the communications between the base station of the own carrier and the base station of the other carrier, receives identification information of PLMN (Public Land Mobile Network), and executes position registration by transmitting identification information inherently assigned to the mobile radio terminal via the base station with which communications can be established. Then, the control unit 100 proceeds to step 3b.

In step 3b, the control unit 100 discriminates whether the mobile radio terminal is located in a domestic area or overseas, on the basis of the identification information of the PLMN received in step 3a. If the control unit 100 discriminates that the mobile radio terminal is located in a domestic area, the control unit 100 proceeds to step 3c. If the control unit 100 discriminates that the mobile radio terminal is located overseas, the control unit 100 proceeds to step 3f.

In step 3c, the control unit 100 discriminates whether the domestic roaming setting flag is ON or OFF, by referring to the roaming setting flag stored in the memory unit 150. If the domestic roaming setting flag is ON, the control unit 100 proceeds to step 3d. If the domestic roaming setting flag is OFF, the control unit 100 proceeds to step 3e.

In step 3d, the control unit 100 stores “full-frequency search setting” indicating the search for the full-frequency band that can be used for the communications between the base station of the own carrier and the carrier of the other carrier, in the memory unit 150, as search setting data, and ends this process. The control unit 100 proceeds to step 2b.

In step 3e, the control unit 100 stores “own network search setting” indicating the search for the frequency band that is used for the communications with the base station of the own carrier, in the memory unit 150, as search setting data, and ends this process. The control unit 100 proceeds to step 2b.

In step 3f, the control unit 100 discriminates whether the foreign roaming setting flag is ON or OFF, by referring to the roaming setting flag stored in the memory unit 150. If the foreign roaming setting flag is ON, the control unit 100 proceeds to step 3g. If the foreign roaming setting flag is OFF, the control unit 100 proceeds to step 3h.

In step 3g, the control unit 100 stores “full-frequency search setting” indicating the search for the full-frequency band that can be used for the communications between the base station of the own carrier and the carrier of the other carrier, in the memory unit 150, as the search setting data, and ends this process. The control unit 100 proceeds to step 2b.

In step 3h, the control unit 100 stores “non full-frequency search setting” indicating that no search for any frequency bands is executed, in the memory unit 150, as the search setting data, and ends this process. The control unit 100 proceeds to step 2b.

In step 2b, the control unit 100 controls the radio communications unit 110 to await an incoming signal transmitted from the base station to the mobile radio terminal at the incoming call. If the radio communications unit 110 receives the incoming signal, the control unit 100 notifies the user of occurrence of the incoming call. If the radio communications unit 110 does not receive the incoming signal, the control unit 100 proceeds to step 2c.

In step 2c, the control unit 100 monitors the receiving state of the radio communications unit 110, and discriminates whether or not the radio signal transmitted from the base station of the system employed for awaiting the incoming signal and whether the mobile radio terminal is located outside the service zone. If the control unit 100 discriminates that the mobile radio terminal is located outside the service zone, the control unit 100 proceeds to step 2d. If the control unit 100 discriminates that the mobile radio terminal is located in the service zone, the control unit 100 proceeds to step 2b and continues awaiting the incoming signal.

In step 2d, the control unit 100 refers to the search setting data stored in the memory unit 150, controls the radio communications unit 110 to sequentially receive the frequency bands in the range set based on the data, and searches for the radio signal transmitted from the base station of the own carrier. The control unit 100 proceeds to step 2e.

In step 2e, control unit 100 discriminates whether or not the radio signal (control information) transmitted from the base station of the own carrier could be received and whether the own carrier network could be detected, as a result of the search in step 2d. If the own carrier network could be detected, the control unit 100 proceeds to step 2f. If the own carrier network could not be detected, the control unit 100 proceeds to step 2g.

In step 2f, the control unit 100 controls the radio communications unit 110 to execute position registration to the own carrier network by transmitting the identification information assigned inherently to the mobile radio terminal via the base station of the own carrier network detected in step 2e. The control unit 100 proceeds to step 2b.

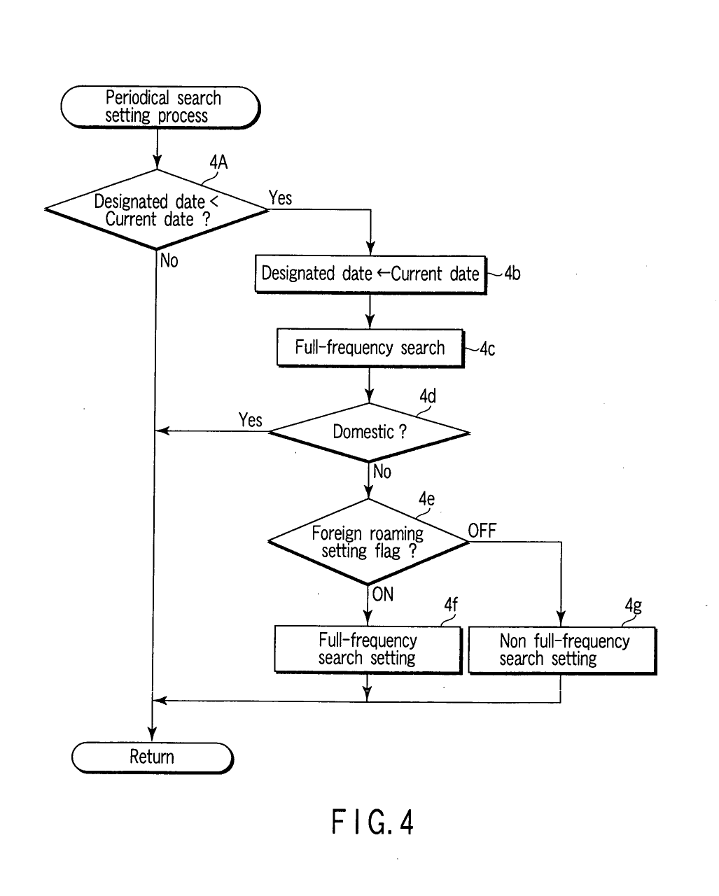

In step 2g, the control unit 100 searches for all the frequencies that can be used for the communications with the base station of the carrier under contract (hereinafter called own carrier) and the base station of the carrier other than the own carrier (hereinafter called the other carrier) and whether the mobile radio terminal is located in the domestic zone or overseas, for example, once a day, by a timer function. If the mobile radio terminal is located overseas, the control unit 100 executes a periodical search setting process for setting the search setting data in accordance with the foreign roaming setting flag stored in the memory unit 150. This process will be described with reference to FIG. 4.

First, in step 4a, the control unit 100 refers to updated date-and-time data stored in the memory unit 150, and discriminates whether or not date set on the basis of the updated date-and-time data is earlier than the current date. If the date set on the basis of the updated date-and-time data is earlier than the current date, the control unit 100 proceeds to step 4b. If the date set on the basis of the updated date-and-time data is the same as or later than the current date, the control unit 100 proceeds to step 2h.

In step 4b, the control unit 100 sets the current date as the updated date-and-time data and stores the current date in the memory unit 150. The control unit 100 proceeds to step 4c.

In step 4c, the control unit 100 controls the radio communications unit 110 to search for all the frequency bands that can be used for the communications with the base station of the own carrier and the base station of the other carrier and receive the identification information of the PLMN. The control unit 100 proceeds to step 4d.

In step 4d, the control unit 100 discriminates whether the mobile radio terminal is located in a domestic area or overseas, on the basis of the identification information of the PLMN received in step 4c. If the control unit 100 discriminates that the mobile radio terminal is located in a domestic area, the control unit 100 ends this process to proceed to step 2h. If the control unit 100 discriminates that the mobile radio terminal is located overseas, the control unit 100 proceeds to step 4e.

In step 4e, the control unit 100 refers to the roaming setting flag stored in the memory unit 150 and discriminates whether the foreign roaming setting flag is ON or OFF. If the foreign roaming setting flag is ON, the control unit 100 proceeds to step 4f. If the foreign roaming setting flag is OFF, the control unit 100 proceeds to step 4g.

In step 4f, the control unit 100 stores “full-frequency search setting” indicating the search for all the frequency bands that can be used for the communications with the base station of the own carrier and the base station of the other carrier, as the search setting data, in the memory unit 150, and ends this process. Thus, the control unit 100 proceeds to step 2h.

In step 4g, the control unit 100 stores “non full-frequency search setting” indicating that no search for any frequency bands is executed, as the search setting data, in the memory unit 150, and ends this process. Thus, the control unit 100 proceeds to step 2h.

In step 2h, the control unit 100 refers to the roaming setting flag stored in the memory unit 150 and discriminates whether or not at least any one of the domestic and foreign roaming setting flags is ON. If at least any one of the domestic and foreign roaming setting flags is ON, the control unit 100 proceeds to step 2i. If both the roaming setting flags are OFF, the control unit 100 proceeds to step 2b.

In step 2i, the control unit 100 controls the radio communications unit 110 to sequentially receive the frequency bands of the other carrier as preset, and searches for the radio signal transmitted from the base station of the other carrier. The control unit 100 proceeds to step 2j.

In step 2j, the control unit 100 discriminates whether the radio signal (control information) transmitted from the base station of the other carrier could be received and whether the other carrier network could be detected, as a result of the search in step 2i. If the other carrier network could be detected, the control unit 100 proceeds to step 2k. If the other carrier network could not be detected, the control unit 100 proceeds to step 2b.

In step 2k, the control unit 100 controls the radio communications unit 110 to execute position registration for the other carrier network by, for example, transmitting the identification information inherently assigned to the mobile radio terminal via the base station of the other carrier network detected in step 2j, and receive the identification information of PLMN. Then, the control unit 100 proceeds to step 21.

In step 21, the control unit 100 discriminates whether the mobile radio terminal is located overseas, on the basis of the identification information of the PLMN received in step 2k. If the control unit 100 discriminates that the mobile radio terminal is located overseas, the control unit 100 proceeds to step 2b. If the control unit 100 discriminates that the mobile radio terminal is located in a domestic area, the control unit 100 proceeds to step 2m.

In step 2m, the control unit 100 controls the radio communications unit 110 to discriminate whether the mobile radio terminal is permitted to execute roaming and whether the other carrier network permits the own carrier network to execute roaming, on the basis of the information transmitted from the other carrier network. If the mobile radio terminal is permitted to execute roaming and the other carrier network permits the own carrier network to execute roaming, the control unit 100 proceeds to step 2b. In the other cases, the control unit 100 proceeds to step 2n.

In step 2n, the control unit 100 refers to the roaming setting flag stored in the memory unit 150, and sets the domestic roaming setting flag to be OFF. Then, the control unit 100 proceeds to step 2o.

In step 2o, the control unit 100 stores “own network search setting” indicating the search for the frequency band employed for the communications with the base station of the own carrier, in the memory unit 150. Then, the control unit 100 proceeds to step 2b.

As described above, even if the domestic roaming setting is ON (domestic roaming setting flag is ON) (YES in step 2h), it is discriminated on the basis of the information transmitted from the other carrier network whether the mobile radio terminal is permitted to execute roaming and whether the other carrier network permits the own carrier network to execute roaming (step 2m). If the mobile radio terminal is not permitted, the roaming setting is turned OFF (step 2n) and, after that, the other carrier network is not searched (NO in step 2h).

Therefore, according to the mobile radio terminal having the above-described configuration, unnecessary power consumption can be reduced since the operation of searching for the roaming destination in the environment that roaming cannot be permitted can be prevented. In a case where the mobile radio terminal is employed, if the foreign roaming setting is ON (foreign roaming setting flag is ON) (YES in step 2h), a trouble that roaming cannot be carried out does not occur since the other carrier network is searched.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Otherwise, the present invention can be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal, comprising:
a memory unit which stores roaming setting;
a detector which, if the roaming setting stored in the memory unit is turned ON in a case where the mobile radio terminal is located outside a service zone of a mobile communications network of a carrier in contact, detects a radio signal transmitted from a mobile communications network of the other carrier; and
a setting control unit which sets the roaming setting stored in the memory unit to be turned OFF, if the roaming to the mobile communications network of the other carrier detected by the detector is not permitted to the mobile radio terminal.

2. The mobile radio terminal according to claim 1, further comprising:
a discriminating unit which discriminates whether the mobile radio terminal is located in a domestic area or overseas, in accordance with a signal received from the mobile communications network; and
a foreign control unit which controls the detector to detect the radio signal transmitted from the mobile communications network of the other carrier, if the discriminating unit discriminates that the mobile radio terminal is located overseas though the roaming setting stored in the memory unit is turned OFF, in a case where the mobile radio terminal is located outside the service zone of the mobile communications network of the carrier in contact.

3. A mobile radio terminal, comprising:
a memory unit which stores roaming setting;
a detector which, if the roaming setting stored in the memory unit is turned ON in a case where the mobile radio terminal is located outside a service zone of a mobile communications network of a carrier in contact, detects a radio signal transmitted from a mobile communications network of the other carrier; and
a setting control unit which sets the roaming setting stored in the memory unit to be turned OFF, if the roaming is not permitted between the mobile communications network of the other carrier detected by the detector and the carrier under contract.

4. The mobile radio terminal according to claim 3, further comprising:
a discriminating unit which discriminates whether the mobile radio terminal is located in a domestic area or overseas, in accordance with a signal received from the mobile communications network; and
a foreign control unit which controls the detector to detect the radio signal transmitted from the mobile communications network of the other carrier, if the discriminating unit discriminates that the mobile radio terminal is located overseas though the roaming setting stored in the memory unit is turned OFF, in a case where the mobile radio terminal is located outside the service zone of the mobile communications network of the carrier in contact.

5. A mobile radio terminal which, if the mobile radio terminal is located outside a service zone of a mobile communications network of a carrier under contract, searches for a radio signal transmitted from a mobile communications network of the other carrier, comprising:
a detector which detects the radio signal transmitted from the mobile communications network of the other carrier, if the mobile radio terminal is located outside the service zone of the mobile communications network of the carrier under contract; and
a control unit which controls not to execute detection of the detector, even if the mobile radio terminal is located outside the service zone of the mobile communications network of the carrier under contract, in a case where the roaming to the mobile communications network of the other carrier detected by the detector is not permitted to the mobile radio terminal.

6. The mobile radio terminal according to claim 5, further comprising:
a discriminating unit which discriminates whether the mobile radio terminal is located in a domestic area or overseas, in accordance with a signal received from the mobile communications network;
wherein the control unit comprises a foreign control unit which controls the detector to detect the radio signal transmitted from the mobile communications network of the other carrier, if the discriminating unit discriminates that the mobile radio terminal is located overseas though the domestic roaming is not permitted, in a case where the mobile radio terminal is located outside the service zone of the mobile communications network of the carrier in contact.

7. A mobile radio terminal which, if the mobile radio terminal is located outside a service zone of a mobile communications network of a carrier under contract, searches for a radio signal transmitted from a mobile communications network of the other carrier, comprising:
a detector which detects the radio signal transmitted from the mobile communications network of the other carrier, if the mobile radio terminal is located outside the service zone of the mobile communications network of the carrier under contract; and
a control unit which controls not to execute detection of the detector, even if the mobile radio terminal is located outside the service zone of the mobile communications network of the carrier under contract, in a case where the roaming is not permitted between the mobile communications network of the other carrier detected by the detector and the carrier under contract.

8. The mobile radio terminal according to claim 7, further comprising:
a discriminating unit which discriminates whether the mobile radio terminal is located in a domestic area or overseas, in accordance with a signal received from the mobile communications network;
wherein the control unit comprises a foreign control unit which controls the detector to detect the radio signal transmitted from the mobile communications network of the other carrier, if the discriminating unit discriminates that the mobile radio terminal is located overseas though the domestic roaming is not permitted, in a case where the mobile radio terminal is located outside the service zone of the mobile communications network of the carrier in contact.
